(19) United States
(12) Patent Application Publication
(10) Pub. No.: US 2012/0024169 A1
(43) Pub. Date: Feb. 2, 2012

(54) Barbecue rack

(76) Inventor: Huang-Hsi Hsu, Taipei (TW)

(21) Appl. No.: 12/805,356

(22) Filed: Jul. 27, 2010

(51) Int. Cl. A47J 37/07

(52) U.S. Cl. 99/450

(57) ABSTRACT

The present invention is to provide a barbecue rack including first and second supporting frames and two fixing elements, wherein the supporting frames are formed by soldering a plurality of spaced metal rods in a crisscross manner respectively, the second supporting frame has an outer surface provided with two parallel positioning rods, and the fixing elements are fastened or soldered to two opposite ends of the first supporting frame respectively and allow a shaft to pass through holes thereof and connect with a motor of a barbecue device. The two ends of each positioning rod can be respectively and securely positioned in corresponding positioning grooves of the fixing elements, so as to connect the supporting frames together to form a receiving space therebetween for receiving food. Thus, when the motor rotates the shaft and barbecue rack, the food in the barbecue rack is conveniently turned for roasting or broiling.

### FIELD OF THE INVENTION

The present invention relates to a barbecue rack, more particularly to a barbecue rack having two supporting frames connected together to form a receiving space therebetween for receiving all kinds of food and having a shaft passing through holes located on an inner side of one of the supporting frames and connecting to a transmission shaft of a motor of a barbecue device, thereby, when the transmission shaft of the motor rotates the shaft and the barbecue rack, the food in the barbecue rack is conveniently turned for roasting or broiling.

### BACKGROUND OF THE INVENTION

Recently, with the improvement of people's living standards, recreational activities have become increasingly popular as a way to relieve stress in life and strengthen interpersonal relationships. One of the most popular recreational activities is the barbecue party, which is usually held outdoors and attended by a group of people who wish to relax in a natural setting while enjoying the company of others. Therefore, barbecue parties nowadays serve not only recreational but also social functions and are the favorite activity of many.

Generally, barbecuing requires the use of a planar metal rack having plural grid holes. The food to be cooked is laid on the planar metal rack, which in turn is placed on a barbecue stove, thus allowing the heat source (e.g., hot charcoal) in the barbecue stove to roast or broil the food. However, such a planar metal rack has the following shortcomings in use:

1. During the roasting or broiling process, the food on the planar metal rack has only one side facing the heat source in the barbecue stove. Therefore, to ensure uniform heating and prevent the food from burning, the barbecuer must pay constant attention to the cooking condition of the food and move or turn the food frequently or regularly with a pair of tongs held in the hand. This moving or turning operation not only is inconvenient but also tends to fatigue the barbecuer's hand. Moreover, the barbecuer's hand may be burned by the heat source while moving or turning the food with the tongs.

2. As the food to be barbecued come in a variety of shapes, those having rounded and smooth configurations (e.g., sausage, hotdog, corn, potato, etc.) are very likely to roll off the planar metal rack while being moved or turned, thus causing a waste of food and the trouble of follow-up cleaning.

Hence, it is an important subject for the manufacturers and designers of barbecue racks to solve the aforementioned problems and develop a novel barbecue rack that can effectively fix food in position and be rotated along with the transmission shaft of the motor of a barbecue device so that not only is the barbecuer spared the inconvenience of having to move or turn the food with a pair of tongs, but also the food can be evenly heated and rapidly cooked.

### BRIEF SUMMARY OF THE INVENTION

In view of the drawbacks of the conventional planar metal rack for barbecuing, the inventor of the present invention made great efforts in research and experiment and finally succeeded in developing a barbecue rack as disclosed herein. It is hoped that, with the present invention, the barbecuer's hand is prevented from fatigue or burn injury which may otherwise result from using a pair of tongs to move or turn the food placed on the conventional planar metal rack. In addition, the barbecue rack of the present invention is configured to fix food in place effectively and prevent the food from rolling to the ground, thereby solving another problem of the conventional planar metal rack.

It is an object of the present invention to provide a barbecue rack which includes a first supporting frame, a second supporting frame, and two fixing elements. The first supporting frame is formed by soldering a plurality of spaced first metal rods in a crisscross manner. Likewise, the second, supporting frame is formed by soldering a plurality of spaced second metal rods in a crisscross manner. In addition, the second supporting frame has an outer surface provided with two parallel positioning rods. Each of the fixing elements has two parallel positioning grooves and a through hole at one end, and two fastening portions and a screw hole at the other end. The fixing elements are fastened or soldered to two opposite ends of the first supporting frame respectively via the fastening portions, thus allowing a shaft to pass through the through holes and be located on an inner side of the first supporting frame. Furthermore, a locking element is screwed into the screw hole of each fixing element to lock the fixing elements in position to the shaft. The two ends of each positioning rod are driven into the corresponding positioning grooves respectively by an external force and, once the external force is removed, resume their original positions, in which the two ends are parallel to each other. Thus, the two ends of each positioning rod are respectively and securely positioned in the corresponding positioning grooves to connect the supporting frames together and thereby allow the inner sides of the two supporting frames to face each other and jointly form a receiving space. A user can place all kinds of food in the receiving space and connect the shaft to the transmission shaft of the motor of a barbecue device. As the transmission shaft of the motor rotates the shaft and hence the barbecue rack, the food in the barbecue rack is conveniently turned for roasting or broiling.

It is another object of the present invention to provide the foregoing barbecue rack, wherein the metal rods are configured to form a plurality of separate regions on each supporting frame. After the supporting frames are connected together, the separate regions on the first supporting frame correspond in position to and face those on the second supporting frame to form a plurality of sub-receiving spaces. The sub-receiving spaces can receive different kinds of food separately to effectively ensure that the different flavors of the food will not interfere with one another.

It is yet another object of the present invention to provide the foregoing barbecue rack, wherein each positioning rod has a bent portion near each end. When the two ends of each positioning rod are deformed by an external force, the bent portions prevent the stress from concentrating at the connected portions between the positioning rods and the second supporting frame. Thus, the positioning rods are effectively prevented from damage which may otherwise result from excessive deformation, and the service life of the barbecue rack is extended.

A further object of the present invention is to provide the foregoing barbecue rack, wherein the barbecue rack further includes at least one spring connected between the positioning rods. By virtue of the resilience of the at least one spring, the positioning rods can be positioned securely in the positioning grooves and are prevented from deformation which may otherwise result from long-term use and prevent the positioning rods from being positioned in the positioning grooves. Thus, the overall stability of the barbecue rack is assured.

### BRIEF DESCRIPTION OF THE SEVERAL VIEWS OF THE DRAWINGS

The invention as well as a preferred mode of use, further objects, and advantages thereof will be best understood by referring to the following detailed description of a preferred embodiment in conjunction with the accompanying drawings, in which:

FIG. 1 is an exploded perspective view of a barbecue rack according to a preferred embodiment of the present invention;

FIG. 2 is a perspective view showing the barbecue rack of the present invention in use;

FIG. 3 is a perspective view showing another configuration of the fixing element of the present invention; and

FIG. 4 is a perspective view showing connection between the positioning rods and the springs of the present invention.

### DETAILED DESCRIPTION OF THE INVENTION

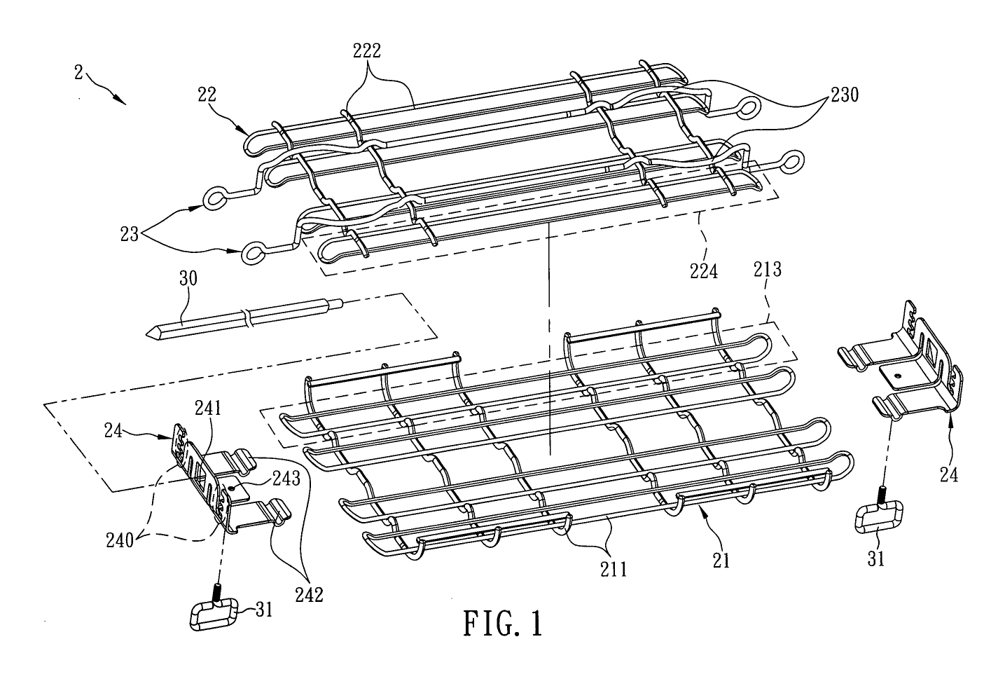

Referring to FIG. 1, a barbecue rack 2 according to a preferred embodiment of the present invention includes a first supporting frame 21, a second supporting frame 22, two positioning rods 23, and two fixing elements 24. The first supporting frame 21 is formed by soldering a plurality of spaced first metal rods 211 in a crisscross manner. The first metal rods 211 are curvedly extended toward an inner side of the first supporting frame 21 at positions corresponding to a periphery of the first supporting frame 21. The second supporting frame 22 is formed by soldering a plurality of spaced second metal rods 222 in a crisscross manner. The second metal rods 222 are curvedly extended toward an inner side of the second supporting frame 22 at least at positions corresponding to two opposite ends of the second supporting frame 22. The positioning rods 23 are soldered longitudinally to an outer surface of the second supporting frame 22 in a parallel manner. The two ends of each positioning rod 23 can deform elastically when subjected to an external force and, once the external force is removed, resume their-original positions, in which the two ends are parallel to each other. Each fixing element 24 has an L-shaped cross section and is formed by bending a metal plate. In addition, each fixing element 24 has one end formed with two parallel positioning grooves 240 and a through hole 241 between the positioning grooves 240. Provided at the other end of each fixing element 24 are two fastening portions 242 and a screw hole 243 between the fastening portions 242. The fixing elements 24 are respectively and symmetrically fastened or soldered to two opposite ends of the first supporting frame 21 via the fastening portions 242, thus allowing a shaft 30 to pass longitudinally through the through holes 241 and be located on the inner side of the first supporting frame 21. A locking element 31 is crewed into the screw hole 243 of each fixing element 24 to secure the fixing elements 24 in position to the shaft 30. The two ends of each positioning rod 23 are pushed into the corresponding positioning grooves 240 by an external force and, after the external force is released, resume their parallel positions such that the two ends of each positioning rod 23 are respectively and securely positioned in the corresponding positioning grooves 240. As a result, the second supporting frame 22 is connected to the first supporting frame 21 while the inner sides of the first and second supporting frames 21, 22 face each other and jointly form a receiving space.

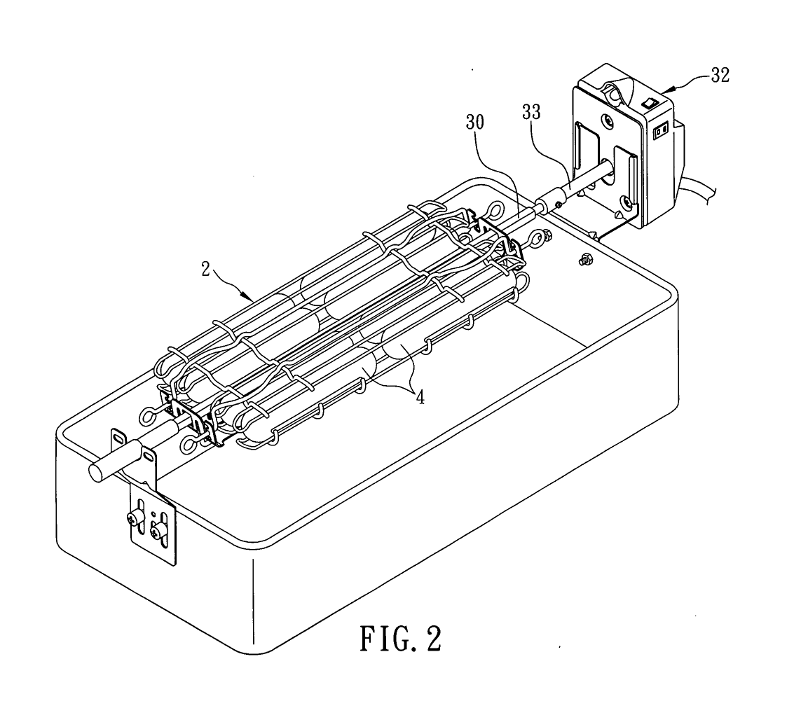

Referring to FIG. 1 and FIG. 2, a user can put a variety of food 4 into the receiving space and connect the shaft 30 to the transmission shaft 33 of the motor of a barbecue device 32. As the transmission shaft 33 of the motor rotates the shaft 30 and thereby rotates the barbecue rack 2, the food 4 is conveniently turned for roasting or broiling. Thus, the present invention effectively prevents the user's hand from fatigue or burn injury which may otherwise result from using a pair of tongs to turn or move the food 4 on a regular basis, as is required when the conventional planar metal rack is used. Also, the barbecue rack 2 can fix the food 4 in place effectively and prevent it from rolling to the ground, thus overcoming yet another drawback of the conventional planar metal rack.

In the present embodiment, referring to FIG. 1, the first metal rods 211 are so configured that a plurality of longitudinally extending, parallel, and separate first regions 213 are formed on the inner side of the first supporting frame 21. Similarly, the second metal rods 222 are so configured that a plurality of longitudinally extending, parallel, and separate second regions 224 are formed on the inner side of the second supporting frame 22, wherein the second regions 224 correspond in position to the first regions 213 respectively. Once the supporting frames 21, 22 are connected, the regions 213, 224 of the first and second supporting frames 21, 22 are located opposite each other and jointly form a plurality of sub-receiving spaces. Therefore, as shown in FIG. 2, a variety of food 4 can be placed separately in the sub-receiving spaces to effectively ensure that the flavors of the food 4 will not interfere with one another.

Referring again to FIG. 1, each positioning rod 23 has a bent portion 230 adjacent to each end. Therefore, when the two ends of each positioning rod 23 are deformed elastically by an external force, the bent portions 230 prevent the stress from concentrating at the connected portions between the positioning rods 23 and the second supporting frame 22 and thereby effectively prevent the positioning rods 23 from damage attributable to excessive deformation. Consequently, the service life of the barbecue rack 2 is extended.

According to the above description, referring to FIG. 2, the barbecue rack 2 of the present invention can wrap the food 4 completely, fix the food 4 in the supporting frames 21, 22 (see FIG. 1), and by virtue of the shaft 30, be rotated about a rotation axis defined by the shaft 30, thus allowing the food 4 to be heated evenly and cooked rapidly. The present invention overcomes the inconveniences and drawbacks of having to use a pair of tongs to turn or move the food 4 on a regular basis.

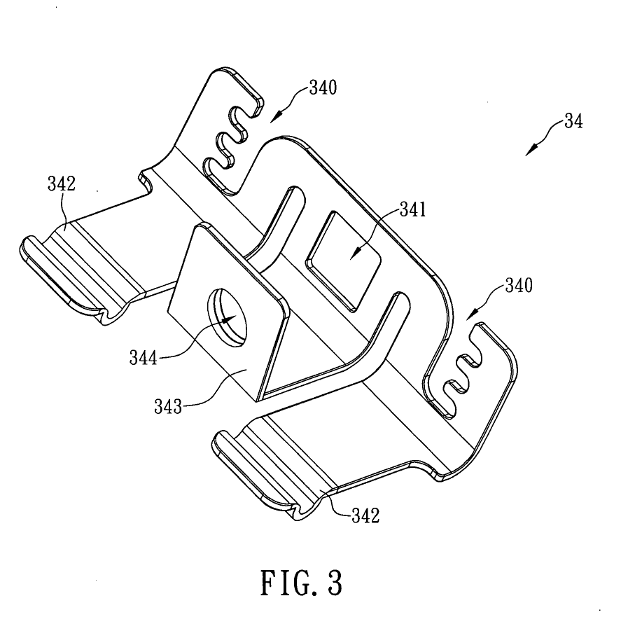

Besides, it should be pointed out that the structures of the fixing elements 24 and the second supporting frame 22 are not limited to those disclosed in the foregoing preferred embodiment and may be modified according to practical needs. For instance, referring to FIG. 3, a fixing element 34 is formed by bending a metal plate and has one end formed with two parallel positioning grooves 340 and a through hole 341 between the positioning grooves 340. In addition, the other end of the fixing element 34 is provided with two fastening portions 342 and a bent extension portion 343 between the fastening portions 342. The bent extension portion 343 has a hole 344 corresponding in position to the through hole 341 so that the shaft 30 (as shown in FIG. 1) can pass through the hole 344 and the through hole 341. Thus, when the shaft 30 is driven to rotate the barbecue rack 2, the fixing element 34 is effectively prevented from rocking or getting loose from the shaft 30, and the barbecue rack 2 is therefore allowed to rotate smoothly.

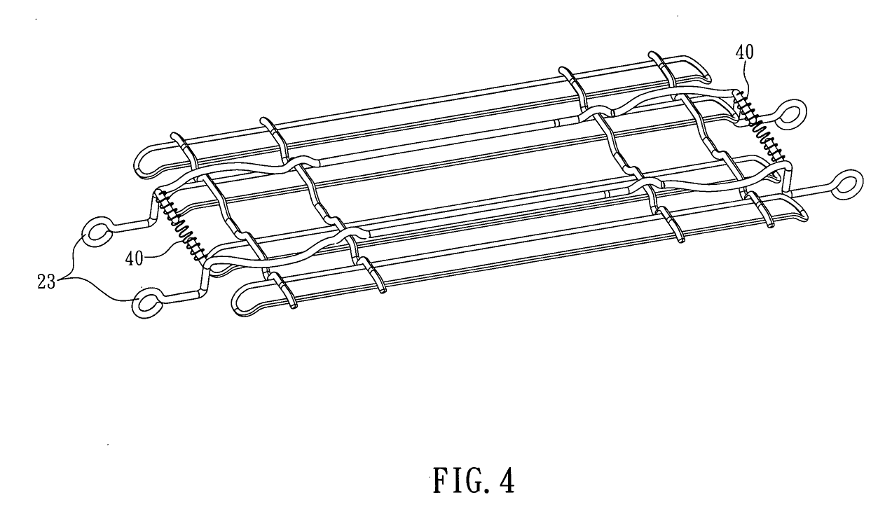

Furthermore, referring to FIGS. 1 and 4, in order to position the positioning rods 23 more securely in the positioning grooves 240 and prevent the positioning rods 23 from elastic fatigue after repeated use (or permanent deformation due to high temperature), two springs 40 are connected between the positioning rods 23. When it is desired to secure the positioning rods 23 in the positioning grooves 240, the positioning rods 23 are pushed toward each other such that the springs 40 are compressed and deformed. Once the positioning rods 23 are released and are secured in the positioning grooves 240, the springs 40 resume their original shapes resiliently. As a result, the positioning rods 23 press tightly against the walls of the positioning grooves 240 and are prevented from getting loose from the fixing elements 24, thereby ensuring the overall stability of the barbecue rack 2.

The embodiment described above is only the preferred embodiment and not intended to limit the structural features of the present invention. For instance, the number and size of the springs 40 can be increased or decreased according to practical needs. Therefore, all equivalent changes which are based on the technical contents disclosed herein and easily conceivable by a person skilled in the art should fall within the scope of the present invention, which is defined only by the appended claims.

What is claimed is:

1. A barbecue rack, comprising:
a first supporting frame formed by soldering a plurality of spaced first metal rods in a crisscross manner, wherein the first metal rods are curvedly extended toward an inner side of the first supporting frame at positions corresponding to a periphery of the first supporting frame;
a second supporting frame formed by soldering a plurality of spaced second metal rods in a crisscross manner;
two positioning rods soldered longitudinally to an outer surface of the second supporting frame in a parallel manner, wherein each said positioning rod has two ends which can deform elastically when subjected to an external force and, once the external force is removed, become parallel to each other again; and
two fixing elements each formed by bending a metal plate, each said fixing element having an end formed with two parallel positioning grooves and a through hole between the positioning grooves, each said fixing element further having an opposite end provided with two fastening portions and a screw hole between the fastening portions, the fixing elements being respectively and symmetrically fastened or soldered to two opposite ends of the first supporting frame via the fastening portions, thus allowing a shaft to pass longitudinally through the through holes and be located on the inner side of the first supporting frame, there being a locking element screwed into the screw hole of each said fixing element such that the fixing elements are fixed in position to the shaft, the two ends of each said positioning rod being driven into corresponding ones of the positioning grooves by the external force and, after the external force is removed, becoming parallel to each other again and hence securely positioned in the corresponding positioning grooves, thereby connecting the second supporting frame to the first supporting frame and allowing the inner side of the first supporting frame and an inner side of the second supporting frame to face each other and jointly form a receiving space.

2. The barbecue rack of claim 1, wherein the second metal rods are curvedly extended toward the inner side of the second supporting frame at least at positions corresponding to two opposite ends of the second supporting frame.

3. The barbecue rack of claim 1, wherein the first metal rods are so configured that a plurality of separate first regions are formed on the inner side of the first supporting frame.

4. The barbecue rack of claim 2, wherein the first metal rods are so configured that a plurality of separate first regions are formed on the inner side of the first supporting frame.

5. The barbecue rack of claim 3, wherein the second metal rods are so configured that a plurality of separate second regions are formed on the inner side of the second supporting frame, the second regions corresponding in position to the first regions such that the corresponding said first and second regions form a plurality of sub-receiving spaces.

6. The barbecue rack of claim 4, wherein the second metal rods are so configured that a plurality of separate second regions are formed on the inner side of the second supporting frame, the second regions corresponding in position to the first regions such that the corresponding said first and second regions form a plurality of sub-receiving spaces.

7. The barbecue rack of claim 5, wherein each said positioning rod has a bent portion near each of its two ends.

8. The barbecue rack of claim 6, wherein each said positioning rod has a bent portion near each of its two ends.

9. The barbecue rack of claim 7, wherein each said fixing element has an L-shaped cross section.

10. The barbecue rack of claim 8, wherein each said fixing element has an L-shaped cross section.

11. The barbecue rack of claim 9, further comprising at least a spring connected between the positioning rods.

12. The barbecue rack of claim 10, further comprising at least a spring connected between the positioning rods.

13. The barbecue rack of claim 7, wherein each said fixing element is provided with a bent extension portion which is located between two corresponding said fastening portions and which has a hole corresponding in position to a corresponding said through hole so that the shaft can pass through the hole and the corresponding through hole.

14. The barbecue rack of claim 8, wherein each said fixing element is provided with a bent extension portion which is located between two corresponding said fastening portions and which has a hole corresponding in position to a corresponding said through hole so that the shaft can pass through the hole and the corresponding through hole.

15. The barbecue rack of claim 13, further comprising at least a spring connected between the positioning rods.

16. The barbecue rack of claim 14, further comprising at least a spring connected between the positioning rods.
